(19) United States
(12) Patent Application Publication
(10) Pub. No.: US 2008/0156296 A1
(43) Pub. Date: Jul. 3, 2008

(54) COMMON-RAIL FUEL INJECTION SYSTEM

(75) Inventor: Hiroaki OCHIAI, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/953,476

(22) Filed: Dec. 10, 2007

(30) Foreign Application Priority Data
Dec. 27, 2006 (JP) 2006-353252

(51) Int. Cl. F02M 69/46

(52) U.S. Cl. 123/456; 138/40

(57) ABSTRACT

A common-rail fuel injection system includes an injector, a flow damper, a common rail having a rail main body, a piston upstream side supply passage, a piston upstream side orifice disposed in the upstream side supply passage to reduce its cross-sectional area, a piston downstream side supply passage, and a piston downstream side orifice disposed in the downstream side supply passage to reduce its cross-sectional area. The damper includes a valve body having a fuel passage, one end of which communicating with the main body and the other end of which communicating with the injector, and a piston slidably held in the fuel passage. Fuel flows from a pressure accumulating chamber in the main body into the piston through the upstream side supply passage, and flows from the piston into the injector through the downstream side supply passage.

### CROSS REFERENCE TO RELATED APPLICATION

The present application is based on, claims priority to, and incorporates herein by reference Japanese Patent Application No. 2006-353252 filed on Dec. 27, 2006.

### BACKGROUND OF THE INVENTION

1. Field of the Invention

The present invention relates to a common-rail fuel injection system.

2. Description of Related Art

A flow damper typically includes a valve body, a piston, a spring, and a stopper. A fuel passage is formed in the valve body having a generally cylindrical shape. The piston slides in its axial direction along a piston sliding hole formed inward of the valve body. The spring urges the piston to an upstream side in a fuel flow direction. The stopper restricts displacement of the piston toward the upstream side as described, for example, in Japanese Patent Application No. JP2001-50141A corresponding to U.S. Pat. No. 6,357,415.

The piston has a throttle passage, which communicates between upstream and downstream sides of the fuel passage.

When a fuel flow in a downstream direction in the fuel passage abnormally increases because of malfunction of an injector such as an excessive fuel outflow, the piston is moved toward the downstream side, and a valve portion of the piston engages a valve seat of the valve body to block the fuel passage. In this manner, when a failure of the flow damper is caused by any one of a number of possibilities, the flow damper stops an outflow of high-pressure fuel.

The piston is moved according to a fuel flow generated when the injector injects fuel, and thereby pulsing motion in an injector pipe is promoted.

To avoid the above problem, it is proposed that an orifice, which corresponds to a piston upstream side orifice, is formed in the stopper.

However, in a conventional common-rail fuel injection system, the pulsing motion generated when the injector injects fuel affects the piston located on the downstream side, or on an injector-side of the orifice in the fuel flow direction. As a result, the piston is moved quickly, thereby producing a small pulsing motion reduction effect on inlet pressure of the injector.

Accordingly, by making an orifice diameter extremely small, volume fluctuation on the upstream side, or on an opposite side of the injector, of the piston in the fuel flow direction is restricted, so that the movement of the piston can be restricted. However, when the orifice diameter is made extremely small, the orifice is difficult to produce, and consequently low productivity of the flow damper is caused.

### SUMMARY OF THE INVENTION

The present invention addresses the above and other disadvantages. Thus, it is an objective of the present invention to provide a common-rail fuel injection system that avoids low productivity and produces a significant pulsing motion reduction effect on inlet pressure of an injector.

To achieve the objective of the present invention, there is provided a common-rail fuel injection system including an injector, a flow damper, a common rail, a piston upstream side supply passage, a piston upstream side orifice, a piston downstream side supply passage, and a piston downstream side orifice. The injector is for injecting fuel. The common rail has a rail main body for accumulating pressure of high-pressure fuel, which is supplied to the injector through the flow damper. The flow damper includes a valve body and a piston. The valve body has a fuel passage therein. One end portion of the fuel passage communicates with the rail main body. The other end portion of the fuel passage communicates with the injector. The piston is slidably held in the fuel passage. Fuel flows from a pressure accumulating chamber in the rail main body into the piston through the piston upstream side supply passage. The piston upstream side orifice is disposed in the piston upstream side supply passage to reduce a cross-sectional area of the piston upstream side supply passage. Fuel flows from the piston into the injector through the piston downstream side supply passage. The piston downstream side orifice is disposed in the piston downstream side supply passage to reduce a cross-sectional area of the piston downstream side supply passage.

To achieve the objective of the present invention, there is also provided a flow damper in a common-rail fuel injection system including an injector for injecting fuel, high-pressure fuel supplied to the injector through the flow damper. The flow damper includes a valve body, a first supply passage, and a second supply passage. The valve body has a fuel passage, one end portion of the fuel passage communicating with a high-pressure fuel supply and an other end portion of the fuel passage communicating with the injector, the fuel passage having a piston slidably held therein, the fuel passage having an upstream side and a downstream side in relation to the piston and a fuel flow direction. The first supply passage is located on the upstream side, through which the high-pressure fuel flows into the fuel passage, a first orifice disposed in the first supply passage to reduce a cross-sectional area thereof. The second supply passage is located on the downstream side, through which fuel flows from fuel passage into the injector, a second orifice disposed in the second supply passage to reduce a cross-sectional area thereof.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view illustrating a flow damper according to an embodiment of the invention; and

FIG. 2 is a schematic view illustrating a configuration of a common-rail fuel injection system according to the embodiment.

### DETAILED DESCRIPTION OF THE INVENTION

A common-rail fuel injection system according to an embodiment of the present invention has a flow damper including a valve body and a piston. The valve body has a fuel passage, one end of which communicates with a rail main body for accumulating pressure of high-pressure fuel, and the other end of which communicates with an injector for injecting fuel. The piston is slidably held in the fuel passage.

The common-rail fuel injection system includes a piston upstream side orifice in a piston upstream side supply passage, through which fuel flows from a pressure accumulating chamber in the rail main body to the piston. The piston upstream side orifice reduces a flow passage area of the piston upstream side supply passage. The common-rail fuel injection system also includes a piston downstream side orifice in a piston downstream side supply passage, through which fuel flows from the piston to the injector. The piston downstream side orifice reduces a flow passage area of the piston downstream side supply passage. Accordingly, the orifices are provided respectively on upstream and downstream sides of the piston in a fuel flow direction. In the following embodiment, the orifices on the upstream and downstream sides of the piston are provided in the flow damper.

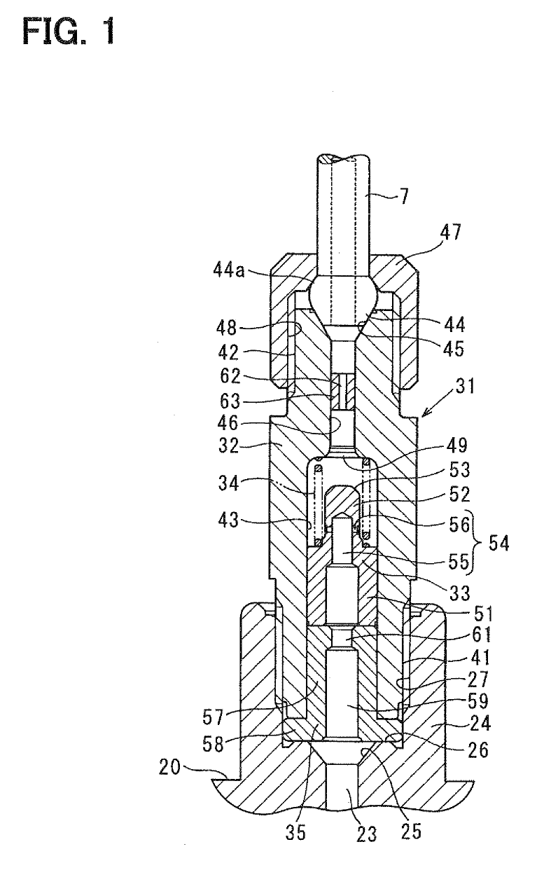

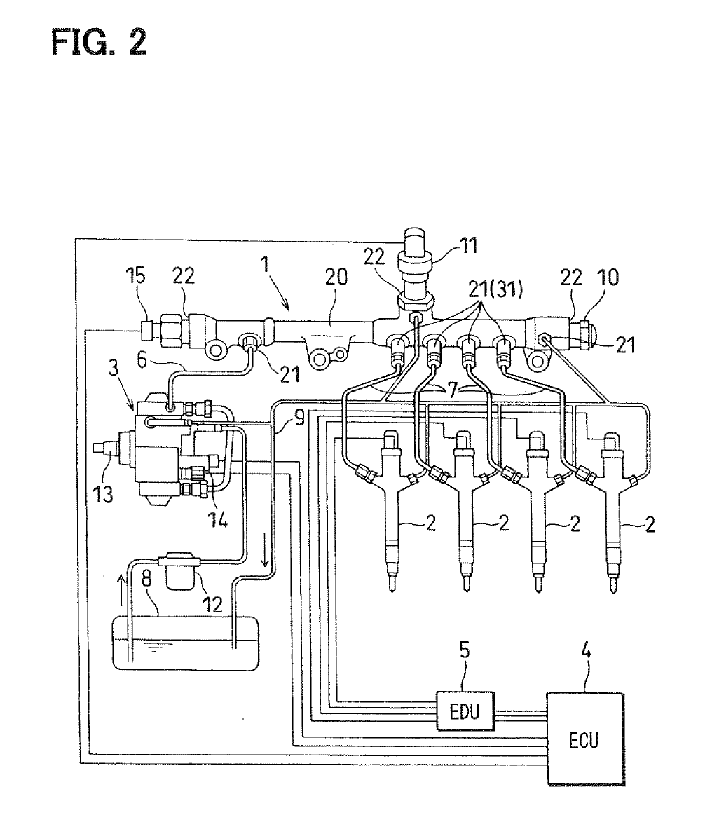

In accordance with the present embodiment, an exemplary common-rail fuel injection system is described with reference to FIG. 2, and an exemplary flow damper is described with reference to FIG. 1.

### (Common-Rail Fuel Injection System)

The common-rail fuel injection system in FIG. 2 injects fuel into each cylinder of an engine, such as, for example, a diesel engine (not shown). The common-rail fuel injection system includes a common rail 1, injectors 2, a supply pump 3, an engine electronic control unit (ECU) 4, and an electronic driver unit (EDU) 5.

The common rail 1 is a pressure accumulating container for accumulating, under a high-pressure, fuel supplied to the injectors 2. The common rail 1 is connected to a discharge outlet of the supply pump 3, which force-feeds high-pressure fuel through a high-pressure pump pipe 6 in order to accumulate common rail pressure, which corresponds to fuel injection pressure. The common rail 1 is also connected to injector pipes 7, which supply high-pressure fuel to each of the injectors 2.

Flow dampers 31 are provided at corresponding connections between the common rail 1 and the injector pipes 7. The flow dampers 31 are described in greater detail hereinafter.

A pressure limiter 10 is attached to a relief pipe 9, through which fuel is returned to a fuel tank 8 from the common rail 1. The pressure limiter 10 is a pressure safety valve opened to keep common rail pressure less than or equal to a limit set pressure when common rail pressure is higher than the limit set pressure.

A decompression valve 11 is attached to the common rail 1. The decompression valve 11 can be opened in response to a valve opening indication signal sent from the ECU 4 to rapidly decrease common rail pressure through the relief pipe 9. By attaching the decompression valve 11 to the common rail 1, the ECU 4 can control the common rail pressure allowing a rapid decrease in the pressure corresponding to a traveling condition of a vehicle to be performed. In addition, the decompression valve 11 is not provided for another model of the common rail.

Each of the injectors 2 is disposed in a corresponding cylinder of the engine, and injects and thereby supplies fuel into the corresponding cylinder. The injectors 2 are connected to respective downstream ends of the injector pipes 7 that branch from the common rail 1. Each of the injectors 2 includes a fuel injection nozzle for injecting and supplying high-pressure fuel, the pressure of which is accumulated in the common rail 1, into the corresponding cylinder, and an electromagnetic valve for controlling a lift of a needle received in the fuel injection nozzle.

Any leaking fuel from the injectors 2 can be returned to the fuel tank 8 through the relief pipe 9.

The supply pump 3 is a high-pressure fuel pump that force-feeds high-pressure fuel into the common rail 1. The supply pump 3 has a feed pump that draws fuel in the fuel tank 8 to the supply pump 3 through a filter 12. The supply pump 3 compresses fuel drawn by the feed pump to have high pressure, and force-feeds the fuel into the common rail 1. The feed pump and the supply pump 3 are driven by a common camshaft 13. The camshaft 13 is driven to rotate by the engine.

The supply pump 3 has a fuel flow passage that leads fuel into a compression chamber where fuel is pressurized to have high pressure. A suction control valve (SCV) 14 for regulating a degree of opening of the fuel flow passage is provided in the fuel flow passage. The SCV 14 is controlled by a pump drive signal from the ECU 4 to regulate an amount of fuel drawn into the compression chamber, thereby changing a discharge amount of fuel to be force-fed into the common rail 1. The SCV 14 regulates common rail pressure by regulating the discharge amount of fuel force-fed into the common rail 1. Accordingly, the ECU 4 controls the common rail pressure to a pressure corresponding to the traveling condition of the vehicle, by controlling the SCV 14.

The ECU 4 includes a central processing unit (CPU) that performs control processing and arithmetic processing, a storage unit that stores various programs and data, for example, a read only memory (ROM), a stand-by ransom access memory (RAM), or memories such as an electrically erasable programmable ROM and RAM, and a microcomputer that has a known configuration and includes functions of an input circuit, output circuit, and power supply circuit. The ECU 4 performs arithmetic processing of various types based on signals from sensors loaded by the ECU 4, namely, engine parameters that are signals corresponding to an operating condition of an occupant and operating condition of the engine.

Sensors such as a rail pressure sensor 15 for detecting common rail pressure, an accelerator sensor for detecting a degree of opening of throttle valve, a rotational speed sensor for detecting a rotational speed of the engine, and a water temperature sensor for detecting coolant temperature of the engine are connected to the ECU 4 as means for detecting the operating condition and the like.

As an example of specific computing performed in the ECU 4, control by the ECU 4 includes an injector control system, in which the injectors 2 are controlled to be driven, and a rail pressure control system, in which the SCV 14 is controlled to be driven.

The injector control system calculates an injection pattern, target injection amount, and injection starting time and calculates an injector valve opening signal, based on programs stored in the ROM and the engine parameters loaded by the RAM with respect to each injection of fuel.

The rail pressure control system calculates target rail pressure based on programs stored in the ROM and the engine parameters loaded by the RAM. The rail pressure control system calculates an SCV drive signal for conforming real rail pressure, which is calculated using the rail pressure sensor 15, to the target rail pressure

The EDU 5 includes an injector drive circuit and a pump drive circuit. The injector drive circuit passes a valve opening driving current through the electromagnetic valve of the injector 2 based on the injector valve opening signal sent from the ECU 4. The pump drive circuit passes a driving current through the SCV 14 based on the SCV drive signal, also referred to as a duty signal sent from the ECU 4. The EDU 5 may be disposed in the same case as the ECU 4.

### (Common Rail 1)

The common rail 1 includes a rail main body 20 having a pipe shape, in which superhigh pressure fuel is stored, and a pipe connecting means 21 for connecting the high-pressure pump pipe 6, the relief pipe 9, and the injector pipes 7 to the rail main body 20. Besides the pipe connecting means 21, the rail main body 20 has a functional component connecting portion 22 for attaching the pressure limiter 10, the decompression valve 11, and the rail pressure sensor 15 to the rail main body 20.

Additionally, the pressure limiter 10 and the decompression valve 11 may be provided integrally with the rail main body 20, and the decompression valve 11 does not need to be used.

As shown in FIG. 2, after forming the rail main body 20 by forging, and holes and planar portions, for example, an in-rail passage, a fuel hole 23, and a first plane 26, may be formed on the rail main body 20. Alternatively, the rail main body 20 may be formed from an inexpensive piping material, and many pipe connecting means 21 may be provided for the piping material in its axial direction at low cost.

The rail main body 20 is made from hard metal such as iron, and the in-rail passage, which is a pressure accumulating chamber (not shown) for high-pressure fuel, is formed in the rail main body 20 in its longitudinal direction.

As shown in FIG. 1, the fuel holes 23, through which the in-rail passage and the outside communicate, are formed on a lateral surface of the rail main body 20. The fuel holes 23 communicate the high-pressure pump pipe 6, the relief pipe 9, and the injector pipes 7, and are formed by hole-drilling with an appropriate distance therebetween in an axial direction of the rail main body 20.

### (Flow Damper 31)

The flow dampers 31 in FIG. I are respectively provided between the rail main body 20 and the injector pipes 7 for the pipe connecting means 21 The rail main body 20, to which the flow dampers 31 are attached, is described.

Cylindrical bosses 24 are formed with an appropriate distance therebetween in the axial direction of the rail main body 20. The fuel hole 23 opens on a generally central portion of a bottom surface of the cylindrical boss 24.

A chamfered portion 25 spreading outward is formed at an outside opening of the fuel hole 23, and an opening area of the outside opening of the fuel hole 23 increases at the chamfered portion 25.

The annular first plane 26 is formed around the chamfered portion 25 on the bottom surface of the cylindrical boss 24.

A first female screw 27, with which the flow damper 31, more specifically, a valve body 32 described below, is fastened to the cylindrical boss 24, is formed on an inner circumferential surface of the cylindrical boss 24. In the present embodiment, the cylindrical boss 24 is formed integrally with the rail main body 20. However, female screw components such as a nut may be fixed on and integrated with the rail main body 20 by welding or the like.

The flow damper 31 includes the valve body 32, a piston 33, a spring 34, and a cap 35. The valve body 32 is fastened to the rail main body 20. The piston 33 slides inside the valve body 32. The spring 34 urges the piston 33 upstream in a fuel flow direction. The cap 35 is attached to an upstream side-portion of the valve body 32 in the fuel flow direction.

Each component of the flow damper 31 is described below in detail, with a rail main body 20-side of the flow damper 31 referred to as ‘lower’ or ‘down’, and an injector pipe 7-side of the flow damper 31 as ‘upper’.

### (Valve Body 32)

The valve body 32 having a generally cylindrical shape is made from hard metal such as iron, and has a fuel passage that includes an upper fuel passage 46 and a piston sliding hole 43 along its shaft axis.

A first male screw 41 screwed into the first female screw 27 of the rail main body 20, is formed on an outer circumferential surface of a lower portion of the valve body 32. A second male screw 42 for attaching the injector pipe 7 is formed on an outer circumferential surface of an upper portion of the valve body 32.

An apical surface of the first male screw 41 has a plane surrounding an opening of the piston sliding hole 43.

A pressure receiving seating surface 45 is formed on an apical surface of the second male screw 42. The pressure receiving seating surface 45 has a conical tapered shape, and a conical portion 44 formed at an end portion of the injector pipe 7 is inserted into the pressure receiving seating surface 45. The upper fuel passage 46 opens at the bottom of the pressure receiving seating surface 45.

A second female screw 48 formed on an inner circumferential surface of a pipe fastening screw member 47 is screwed on the second male screw 42.

The pipe fastening screw member 47 is screwed on the second male screw 42, being locked on a step 44a of the conical portion 44 of the injector pipe 7. By strongly screwing the pipe fastening screw member 47 on the second male screw 42, the conical portion 44 of the injector pipe 7 is strongly pressed on the pressure receiving seating surface 45, thereby forming a pipe sealing surface, which is an oil-tight surface, or a closely-attached surface between the injector pipe 7 and the valve body 32.

The piston sliding hole 43 for slidably holding the piston 33 in its axial direction between a lower end portion and generally central portion of the valve body 32 is formed along the shaft axis of the valve body 32. The upper fuel passage 46, which communicates between an upper end portion of the valve body 32 and the piston sliding hole 43, is formed above the central portion of the valve body 32. The upper fuel passage 46 and the piston sliding hole 43 constitute the fuel passage in the valve body 32.

One end of the fuel passage communicates with the fuel hole 23 of the rail main body 20 that accumulates pressure of high-pressure fuel. The other end of the fuel passage communicates with the injector 2 through the injector pipe 7.

A valve sheet 49 having a generally conical shape and spreading downward is formed between the upper fuel passage 46 and the piston sliding hole 43. The piston sliding hole 43 and the upper fuel passage 46 are formed coaxially with each other, thereby keeping the valve sheet 49 of the valve body 32 and a valve portion 53 (described later) of the piston 33 coaxial with each other.

### (Piston 33)

The piston 33 is made from materials that are not damaged under high pressure of fuel, such as iron, aluminum, and resin. The piston 33 is slidably held in an axial direction in the piston sliding hole 43 of the valve body 32, which is a part of the fuel passage. The piston 33 includes a large diameter sliding portion 51 and a projecting portion 52 with a step between the large diameter sliding portion 51 and the projecting portion 52. The large diameter sliding portion 51 located on a lower side of the piston 33 slides directly on the piston sliding hole 43. The projecting portion 52 located on an upper side of the piston 33 has a smaller diameter. The valve portion 53, which engages the valve sheet 49 of the valve body 32 to block the upper fuel passage 46, is formed on an upper end portion of the projecting portion 52. A lower end portion of the spring 34 contacts the step between the large diameter sliding portion 51 and the projecting portion 52, so that the piston 33 is urged downward by the spring 34.

A throttle passage 54, which communicates between a lower surface of the large diameter sliding portion 51 and a lateral surface of the projecting portion 52, is formed in the piston 33. The throttle passage 54 includes a piston central hole 55 and a throttle 56 that is an orifice of the piston central hole 55. The piston central hole 55 extends from a generally central portion of the lower surface of the large diameter sliding portion 51 to a halfway position of the projecting portion 52. The throttle 56 communicates between the piston central hole 55 and the outer circumferential surface of the projecting portion 52.

### (Spring 34)

The spring 34 is a compression coil spring that urges the piston 33 downward. An actuation value of the flow damper 31, which is a set value for blocking of an outflow of high-pressure fuel by the flow damper 31, is set according to a compressive load of the spring 34. The actuation value of the flow damper 31 may be set according to a diameter of the throttle 56, length of the projecting portion 52 in its axial direction, or a diameter of a piston upstream side orifice 61 (described below) of the cap 35, in addition to the compressive load of the spring 34.

### (Cap 35)

The cap 35 is made from hard metal having good sealing characteristics, such as iron and copper, and attached to the upstream side-portion of the valve body 32 in the fuel flow direction. The cap 35 includes a small diameter portion 57 that is a stopper portion fitted into an inner circumferential surface of the piston sliding hole 43, a large diameter portion 58 that is a gasket portion located between the valve body 32 and the rail main body 20, and a communicating portion 59 that communicates between the fuel hole 23 of the rail main body 20 and an upstream side of the fuel passage.

The small diameter portion 57 has a generally columnar shape. An outer diameter of the small diameter portion 57 is slightly smaller than an inner diameter of the piston sliding hole 43 so that the small diameter portion 57 is fitted into the piston sliding hole 43 with a small gap between the inner circumferential surface of the piston sliding hole 43 and an outer circumferential surface of the small diameter portion 57. More specifically, the gap is set such that, even if the valve body 32 is strongly fastened to the rail main body 20 and consequently a lower portion of the valve body 32 is strained and has a decreased diameter, the piston sliding hole 43 does not press the outer circumferential surface of the small diameter portion 57.

The small diameter portion 57 serves as a stopper for restricting displacement of the piston 33 toward the upstream side in the fuel flow direction. A lower end plane of the piston 33 directly engages a stopper surface that is an upper end plane of the small diameter portion 57.

The small diameter portion 57 has enough length in its axial direction to shift a range, in which the piston 33 directly slides on an inner circumferential surface of the valve body 32, in the axial direction, according to a portion of the valve body 32 strained by fastening force.

The large diameter portion 58 is a ring flange having a slightly smaller diameter than an inner diameter of the cylindrical boss 24. By fastening the valve body 32 to the rail main body 20, the large diameter portion 58 is pressed between the valve body 32 and the rail main body 20 to serve as a gasket. More specifically, upper and lower surfaces of the large diameter portion 58 are formed to be planar, and are pressed between the first plane 26 of the rail main body 20 and the apical surface of the first male screw 41. By screwing the first male screw 41 of the valve body 32 strongly into the first female screw 27 of the rail main body 20, a main body sealing surface, which is an oil-tight surface, or a closely-attached surface where the first plane 26, the cap 35, and the apical surface of the first male screw 41 are strongly pressed together, is formed

The communicating portion 59, through which high-pressure fuel in the fuel hole 23 of the rail main body 20 flows to an upstream side of the piston 33, that is, into the piston central hole 55, is formed in the center of the cap 35.

### (Workings of the Flow Damper 31)

When a fuel flow in a downstream direction is small, such as in the case of micro injection, a pressure difference between before and after the throttle passage 54 is small, so that the piston 33 engages the small diameter portion 57 of the cap 35. In the above state, fuel supplied to the piston central hole 55 through the communicating portion 59 flows to the injector 2 after passing through the throttle passage 54 alone.

When the fuel flow in the downstream direction increases in a normal range, such as in the case of extensive injection, the pressure difference between before and after the throttle passage 54 increases, so that the piston 33 disengages from the cap 35 to be displaced to the upper side, or to the downstream side. In the above state, fuel that have passed through the communicating portion 59 is supplied to the injector 2 after passing through the throttle passage 54 and through a sliding clearance between the large diameter sliding portion 51 of the piston 33 and the piston sliding hole 43.

When the fuel flow in the downstream direction abnormally increases because of malfunction of the injector 2 such as an excessive fuel outflow and accordingly the pressure difference between before and after the throttle passage 54 is equal to or larger than a predetermined pressure difference, the piston 33 is displaced to the upper side, so that the valve portion 53 located on the upper end portion of the projecting portion 52 engages the valve sheet 49 of the valve body 32 to block the upper fuel passage 46.

In this manner, when the fuel flow in the downstream direction increases to equal to or larger than a predetermined amount due to some failure of the flow damper 31 by any possibility, the flow damper 31 stops the outflow of high-pressure fuel.

### (Characteristics of the Embodiment)

The common-rail fuel injection system has the piston upstream side orifice 61 in a piston upstream side supply passage, through which fuel flows from the pressure accumulating chamber in the rail main body 20 to the piston 33. The piston upstream side orifice 61 reduces a flow passage area of the piston upstream side supply passage.

In the present embodiment, the piston upstream side orifice 61 is provided in the cap 35, which is attached to the upstream side-portion of the valve body 32 in the fuel flow direction. More specifically, the piston upstream side orifice 61 is formed in an upper area of the communicating portion 59 of the cap 35. The piston upstream side orifice 61 reduces a flow passage area of the communicating portion 59.

A piston downstream side orifice 62 is provided in a piston downstream side supply passage, through which fuel flows from the piston 33 to the injector 2. The piston downstream side orifice 62 reduces a flow passage area of the piston downstream side supply passage.

In the present embodiment, the piston downstream side orifice 62 is provided in the upper fuel passage 46 located on a downstream side of the piston 33 in the fuel flow direction. More specifically, the piston downstream side orifice 62 is formed in a generally cylindrical press-fit member 63 press-fitted into the upper fuel passage 46.

As described above, the common-rail fuel injection system in the present embodiment has the orifices, such as the piston upstream side orifice 61 and the piston downstream side orifice 62 that are on upstream and downstream sides of the piston 33 in the fuel flow direction. Accordingly, (i) volume fluctuation of fuel on the upstream and downstream sides of the piston 33 in the fuel flow direction is restricted, so that the piston 33 slows down, and (ii) pulsing motion generated when the injector 2 injects fuel is reduced through the piston downstream side orifice 62, and thereby does not affect the piston 33.

In the above described manner, even if a fuel flow is generated in the injector pipe 7 when the injector 2 injects fuel, the piston 33 is not moved quickly. Consequently, promotion of pulsing motion due to the displacement of the piston 33 is avoided, and thus the pulsing motion of inlet pressure of the injector 2 is reduced.

By providing the piston downstream side orifice 62 in addition to the piston upstream side orifice 61, the pulsing motion of inlet pressure of the injector 2 is reduced. Thus, an orifice diameter does not need to be extremely small. As a result, the piston upstream side orifice 61 and the piston downstream side orifice 62 are easily formed, and thereby productivity of the flow damper 31 is not decreased.

That is, the pulsing motion of inlet pressure of the injector 2 is reduced, with the productivity of the flow damper 31 maintained.

In the present embodiment, the piston downstream side orifice 62 is formed in the upper fuel passage 46 of the valve body 32. More specifically, the piston downstream side orifice 62 is formed in the press-fit member 63 press-fitted into the upper fuel passage 46.

In this manner, the piston downstream side orifice 62 is formed in the valve body 32 by press fitting. Only by press-fitting the press-fit member 63, in which the piston downstream side orifice 62 is formed, into the existing valve body 32, namely, an existing valve body in which the piston downstream side orifice 62 is not formed, the pulsing motion of inlet pressure of the injector 2 is reduced. Accordingly, versatility of the flow damper 31 is expanded, and without increasing its production cost.

In the present embodiment, the piston downstream side orifice 62 is formed in the upper fuel passage 46 of the valve body 32. As a result, only by looking into the upper fuel passage 46, it is determined whether the piston downstream side orifice 62 is formed, so that it is easily determined whether the flow damper 31 is a countermeasure product against pulsing motion, which is an application of the present invention.

Furthermore, the piston upstream side orifice 61 is formed in the cap 35 attached to the upstream side-portion of the valve body 32 in the fuel flow direction. Both the piston upstream side orifice 61 and the piston downstream side orifice 62 are formed in the flow damper 31. Consequently, the pulsing motion of inlet pressure of the injector 2 is reduced only in the flow damper 31 of the embodiment. In other words, the piston upstream side orifice 61 and the piston downstream side orifice 62 do not need to be provided in other positions than in the flow damper 31.

### (Modifications)

In the above embodiment, the piston upstream side orifice 61 is formed in the cap 35 fitted into the valve body 32. Alternatively, the piston upstream side orifice 61 may be formed in a stopper press-fitted into the valve body 32, or in a ring-shaped gasket or stopper pressurized and held between the rail main body 20 and the valve body 32.

As well, the piston upstream side orifice 61 may be formed outside the flow damper 31. More specifically, the piston upstream side orifice 61 may be formed directly in the fuel hole 23, or a member in which the piston upstream side orifice 61 is formed may be placed in the fuel hole 23 by press fitting, for example.

In the above embodiment, the press-fit member 63, in which the piston downstream side orifice 62 is formed, is press-fitted into the upper fuel passage 46 of the valve body 32. Alternatively, the piston downstream side orifice 62 may be formed by thinning the upper fuel passage 46 itself. In other words, the piston downstream side orifice 62 may be formed directly in the valve body 32.

The piston downstream side orifice 62 may also be formed outside the flow damper 31. More specifically, the piston downstream side orifice 62 may be formed halfway through the injector pipe 7 or in a connecting portion between the injector pipe 7 and the injector 2.

Additional advantages and modifications will readily occur to those skilled in the art. The invention in its broader terms is therefore not limited to the specific details, representative apparatus, and illustrative examples shown and described.

What is claimed is:

1 A common-rail fuel injection system comprising:
an injector for injecting fuel;
a flow damper;
a common rail having a rail main body for accumulating pressure of high-pressure fuel, which is supplied to the injector through the flow damper, wherein the flow damper includes:
a valve body having a fuel passage therein, wherein:
one end portion of the fuel passage communicates with the rail main body; and
the other end portion of the fuel passage communicates with the injector; and
a piston that is slidably held in the fuel passage;
a piston upstream side supply passage, through which fuel flows from a pressure accumulating chamber in the rail main body into the piston;
a piston upstream side orifice disposed in the piston upstream side supply passage to reduce a cross-sectional area of the piston upstream side supply passage;
a piston downstream side supply passage, through which fuel flows from the piston into the injector; and
a piston downstream side orifice disposed in the piston downstream side supply passage to reduce a cross-sectional area of the piston downstream side supply passage.

2. The common-rail fuel injection system according to claim 1, wherein the fuel passage on a downstream side of the piston in the valve body in a fuel flow direction includes the piston downstream side supply passage.

3. The common-rail fuel injection system according to claim 2, further comprising a press-fit member that is press-fitted into the piston downstream side supply passage, wherein the piston downstream side orifice is formed in the press-fit member.

4. The common-rail fuel injection system according to claim 1, wherein:
the flow damper further includes a member, which is attached to an upstream side-portion of the valve body in a fuel flow direction to define the piston upstream side supply passage; and
the piston upstream side orifice is formed in the member.

5. A flow damper in a common-rail fuel injection system including an injector for injecting fuel, high-pressure fuel supplied to the injector through the flow damper, the flow damper comprising:
a valve body having a fuel passage, one end portion of the fuel passage communicating with a high-pressure fuel supply and an other end portion of the fuel passage communicating with the injector, the fuel passage having a piston slidably held therein, the fuel passage having an upstream side and a downstream side in relation to the piston and a fuel flow direction;
a first supply passage located on the upstream side, through which the high-pressure fuel flows into the fuel passage, a first orifice disposed in the first supply passage to reduce a cross-sectional area thereof; and
a second supply passage located on the downstream side, through which fuel flows from fuel passage into the injector, a second orifice disposed in the second supply passage to reduce a cross-sectional area thereof.

6. The flow damper according to claim 5, wherein the second orifice disposed in the second supply passage includes a press-fit member press-fitted thereinto.

7. The flow damper according to claim 5, further comprising a member attached to a side-portion of the valve body on the upstream side thereof to define the first side supply passage, the first orifice being formed in the member.
